(19) United States
(12) Patent Application Publication
(10) Pub. No.: US 2025/0314784 A1
(43) Pub. Date: Oct. 9, 2025

(54) COMPUTING COPRESENCE EVENTS BASED ON GPS SIGNAL

(71) Applicant: Uber Technologies, Inc., San Francisco, CA (US)

(72) Inventors: Andrew Yuh-Hsien Wang, San Francisco, CA (US); Kevin John Glancy, San Francisco, CA (US); Sebastian Alejandro Marquez Lutfy, San Francisco, CA (US); Mir Shahrouz Takyar, San Jose, CA (US)

(21) Appl. No.: 19/075,623

(22) Filed: Mar. 10, 2025

Related U.S. Application Data
(60) Provisional application No. 63/631,071, filed on Apr. 8, 2024.

(51) Int. Cl. G01S 19/42; G01S 19/51; G06Q 50/43

(52) U.S. Cl. CPC G01S 19/425; G01S 19/51; G06Q 50/43

(57) ABSTRACT

The disclosed examples are directed to systems and methods for computing copresence of devices using GPS signals. The systems and methods access a plurality of GPS signals comprising a first set of GPS signals associated with a first device and a second set of GPS signals associated with a second device. The systems and methods align the first set of GPS signals with the second set of GPS signals and compute copresence probability for each pair of GPS signals in the aligned first and second sets of GPS signals. The systems and methods smooth the copresence probability for each pair of GPS signals and determine one or more copresence events based on the smoothed copresence probability for each pair of GPS signals.

### CLAIM FOR PRIORITY

This application claims the benefit of priority of U.S. Provisional Application No. 63/631,071, filed Apr. 8, 2024, which is hereby incorporated by reference in its entirety.

### TECHNICAL FIELD

The subject matter disclosed herein generally relates to special-purpose machines configured to determine locations of user devices and to the technologies by which such special-purpose machines become improved compared to other machines that determine locations of user devices.

### BACKGROUND

The reliability and accuracy of operating many transport systems relies on correctly measuring and determining co-presence between devices. Specifically, such transport systems usually compute fares based on how long a user spends in a vehicle. Some transport systems provide estimates to users for when goods will be delivered based on how long providers spend waiting for the goods to be prepared.

### BRIEF DESCRIPTION OF THE DRAWINGS

Some examples are illustrated by way of example and not limitation in the figures of the accompanying drawings.

FIG. 1 is a diagram illustrating a network environment suitable for providing copresence estimation, according to some examples.

FIG. 2 is a block diagram illustrating components of a network system for providing copresence estimation, according to some examples.

FIG. 3 is a plot illustrating a sample logistic function that can be used in accordance with some examples.

FIG. 4 is a flowchart illustrating operations of methods for providing copresence estimation, according to some examples.

FIG. 5 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Typical systems determine whether certain users/devices are co-present or collocated using global positioning system (GPS) information. However, GPS information may not be specific or accurate enough in certain environments. This is especially true in urban areas or urban canyons where high buildings can interfere with satellites or when devices are placed indoors and have no access to the GPS signals. Because GPS may not be accurate on mobile devices, it is not always reliable. Thus, it may be difficult to determine if two user devices are close together or co-located. As such, these systems usually rely on external factors, such as express user input, to detect presence or co-presence of two individuals or two or more devices. While this manner of detecting co-presence generally works, relying on express user input to be provided can add significant delay, which provides inaccurate predictions.

In some cases, users may forget to provide such input indicating that they have arrived/departed from a location, which can skew the data that is being aggregated and/or can result in erroneous fare computations. This can result in inefficient use of resources and can frustrate end users who are relying on durations or fares computed based on such manual user input. The reliance on users providing express input to derive or compute durations of time spent at locations and/or completing a trip is also prone to misuse and/or fraud. For example, a user can indicate a trip has begun early or ended later than it actually did, which can cause fraudulent fares to be computed. There are no known systems that accurately estimate/predict co-presence to automate the process of computing how long users spend together and/or at certain locations.

In the context of a transportation service, when a rider has difficulty finding their driver due to poor visual information, it can lead to a considerable waste of resources. If the app's interface fails to provide clear, real-time location data or if the visual representation of the driver's vehicle on the map is imprecise, riders may end up wandering in search of the vehicle, causing delays and inefficiencies. This scenario is exacerbated in crowded or poorly mapped areas where pinpointing the exact location becomes even more challenging. The time spent by riders in trying to locate drivers translates to lost time for drivers as well, who must remain idle when they could be completing other rides. This inefficiency reduces the number of trips a driver can make in a given period, impacting their earnings and the overall throughput of the service.

From a system perspective, the additional time spent on each pickup extends the active session durations on the network, increasing the load on the servers. This can lead to higher operational costs as the system needs to handle more simultaneous connections and data exchanges than would be necessary with a more efficient pickup process. Moreover, the increased fuel consumption and emissions from drivers' vehicles circling to connect with riders contribute to environmental concerns. In high-demand situations, the cumulative effect of these delays can strain the service's capacity, leading to longer wait times for other users and a decline in service quality. Therefore, providing accurate and user-friendly visual information to facilitate quick and stress-free rider-driver connections is essential for the operational efficiency, economic viability, and environmental sustainability of transportation services.

In one use case, copresence can be used to determine if a rider and driver are co-located (e.g., in the same vehicle) for a ride sharing service and to provide accurate real-time feedback (e.g., audible, visual, and/or haptic feedback) representing the direction and distance between a rider and driver (or between two user devices). If the rider and driver are co-located, then a trip (e.g., transportation service from a pickup location to a drop-off location) can start. If the rider and driver are not co-located, examples can help the rider and driver find each other. Conversely, if the rider and driver are no longer co-located after previously being co-located, then the trip is marked as completed, which can be used to resolve fare disputes or automatically end tracking of the trip. In a further use case, copresence can be used to provide a safety notification (e.g., using haptic feedback) should a rider get into a wrong vehicle or, conversely, into a correct vehicle. In a delivery use case, co-presence can be used to detect that a courier has arrived at a facility to pick up goods (e.g., food) for delivery to a consumer. The disclosed examples provide a robust system that can provide accurate copresence determination based on GPS signals.

For example, the disclosed techniques can compute a fare (the amount paid by a rider or the amount paid to a driver) based on the duration of time, determine when a trip starts/stops, compute how long it takes for a facility (e.g., restaurant or store) to prepare goods for pickup by a courier to deliver to a consumer, and/or any combination thereof. In some cases, the computed duration is aggregated across multiple devices that pick up goods from the same facility to train a prediction model to accurately predict how long the facility takes to prepare goods for delivery or pickup.

In some examples, the disclosed techniques access a plurality of GPS signals comprising a first set of GPS signals associated with a first device and a second set of GPS signals associated with a second device. The disclosed techniques align the first set of GPS signals with the second set of GPS signals and compute copresence probability for each pair of GPS signals in the aligned first and second sets of GPS signals. The disclosed techniques smooth the copresence probability for each pair of GPS signals and determine one or more copresence events based on the smoothed copresence probability for each pair of GPS signals.

The main objective of the GPS based on trip copresence techniques are to determine when a specific driver and rider identifiers are together (co-present) during a specific trip via GPS data. While the disclosed approaches are described in the context of a ridesharing service involving a rider and a driver, similar techniques are applicable in other scenarios such as a courier service in which a courier picks up an item from a certain location (e.g., a merchant or provider of the item). GPS copresence can be determined by comparing the positions and speeds of the rider and driver at matching times. Because both the position and speed of the rider and driver are noisy signals, the disclosed techniques use a probabilistic based (Rician) method to calculate the probability of the rider/driver being copresence at instantaneous points throughout the trip. The disclosed techniques then combine these instantaneous signals to create an overall smoothed copresence status signal. This smoothed copresence status signal is used to determine the major trip events as well as the current copresence status. For example, the smoothed copresence status signal can be used to identify a first copresence event, a first copresence event with speed, a last copresence event, a last conclusive event, a last separation event, and/or a drop-off event.

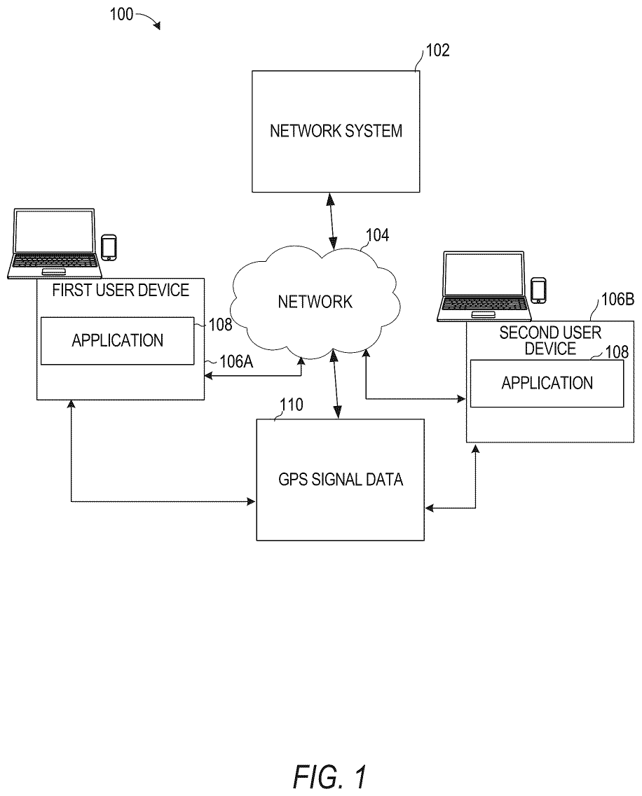

FIG. 1 is a diagram illustrating a network environment 100 suitable for providing copresence duration estimation, according to some examples. The network environment 100 includes a network system 102 communicatively coupled via a network 104 to a first user device 106a and a second user device 106b (collectively referred to as “user devices 106”). The first user device 106a may be a device of a user, courier, or rider for a transportation service, while the second user device 106b is a device of a service provider, facility device (e.g., restaurant or store device), or driver for the transportation service.

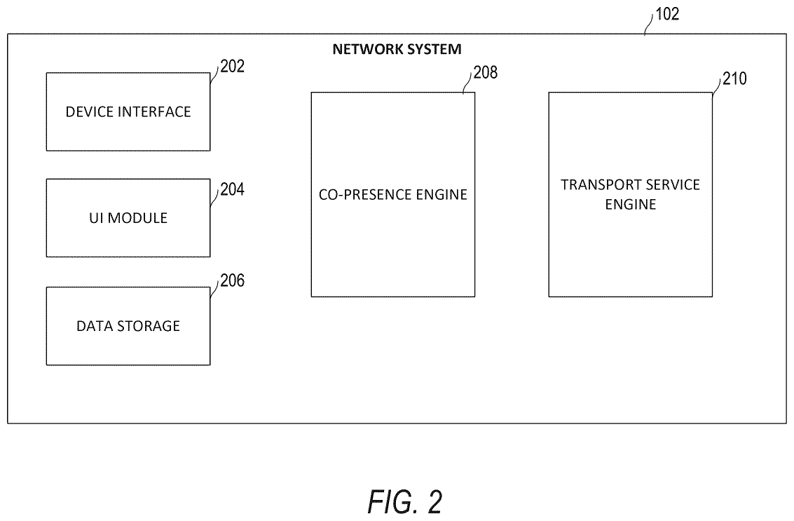

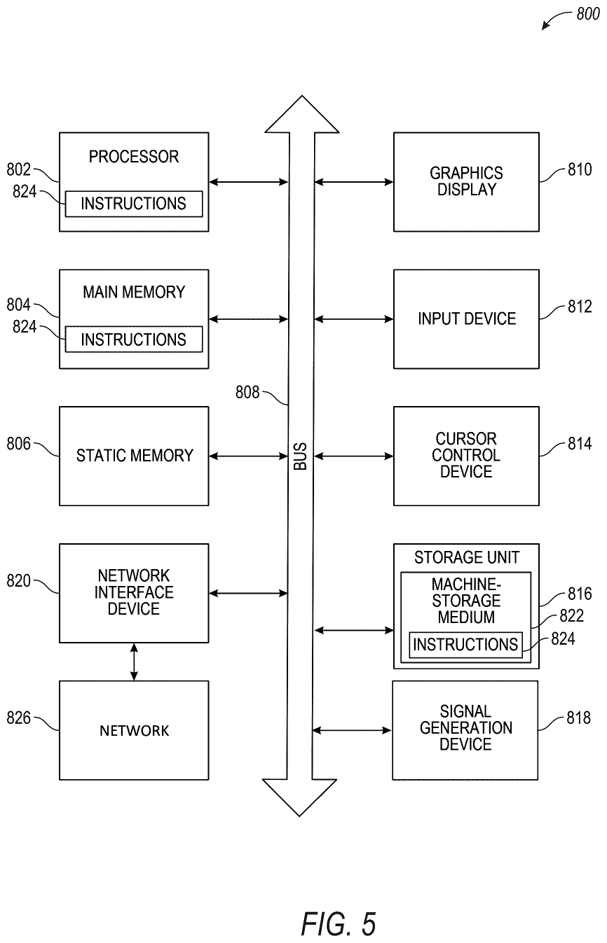

In examples, the network system 102 includes components that obtain and analyze scans received from the user devices 106 to determine copresence of the user devices 106. The components of the network system 102 are described in more detail in connection with FIG. 2 and may be implemented in a computer system, as described below with respect to FIG. 5. While some examples are described in the context of a transportation service (e.g., to transport a person), examples may also be used in delivery services (e.g., to deliver an item, such as food), whereby the first user device 106a is a device of a recipient (consumer) and the second user device 106b is a device of a courier.

The disclosed examples relate to the user devices 106 continuously or periodically collecting global positioning system (GPS) signals and storing such GPS signal data 110 in the network system 102. The GPS signals are associated with an identifier of the user devices 106 from which they are received. For example, a first set of the GPS signal data 110 collected from the first user device 106a can be stored in association with an identifier of the first user device 106a. A second set of the GPS signal data 110 collected from the second user device 106b can be stored in association with an identifier of the second user device 106b.

The components of FIG. 1 are communicatively coupled via the network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In examples, the user devices 106 are portable electronic devices such as smartphones, tablet devices, wearable computing devices (e.g., smartwatches), or similar mobile devices. Alternatively, the user device 106b of the service provider can correspond to an on-board computing system of a vehicle or stationary device at a physical facility (e.g., store, office, or restaurant). The user devices 106 each includes one or more processors, memory, touch screen displays, wireless networking system (e.g., IEEE 802.11), short-range networking system (e.g., BLE devices), cellular telephony support (e.g., LTE/GSM/UMTS/CDMA/HSDPA), and/or location determination capabilities.

The user devices 106 interact with the network system 102 through an application 108 stored thereon. The application 108 of the user devices 106 allows for exchange of information with the network system 102 via user interfaces (UIs), as well as in the background. For example, the application 108 running on the user devices 106 can transmit the GPS signal data 110 to the network system 102, and/or receive a notification of copresence (or lack of copresence) from the network system 102.

In some examples, the application 108 is triggered by the network system 102 to perform the scan for the GPS signal data 110. The network system 102 and/or the application 108 of the first user device 106a that detects the GPS signal data 110 then processes the GPS signals collected from the user devices 106 to process the GPS signals and generate a smoothed overall copresence signal. The smoothed overall copresence signal can be used to determine whether the user devices 106 are co-present and triggers a component of the network system 102 to perform a corresponding operation.

In some examples, the smoothed overall copresence signal can be used to help a rider find a driver. For example, a user interface can be presented on the user devices 106a that includes a map of different vehicles each corresponding to a different user device 106. The first user device 106a can determine the likelihood of copresence between the first user device 106a and the user devices 106 of each vehicle within a certain distance of the first user device 106a. Based on the likelihoods, the user interface can color or display some visual indicator on each vehicle that is presented on the map and/or can generate haptic feedback. Namely, a first vehicle that is associated with an immediate likelihood of copresence can be presented in a first color and a second vehicle that is associated with a near likelihood of copresence can be presented in a second color. This can be provided together with haptic feedback of a first type. This can help the user identify and find the driver that is associated with a trip requested by the user.

In some examples, a determination can be made that the first vehicle is associated with a different trip than the one requested by the user of the first user device 106a. In such cases, the first vehicle can be presented in a third color (e.g., red) even though the first vehicle is associated with the immediate likelihood of copresence to alert the user that the first vehicle is associated with a different trip. The second vehicle can be determined to be associated with the trip requested by the user and, in such cases, the second vehicle can be presented with the first color instead of the second color even though the second vehicle is associated with the near likelihood of copresence to help the user find the second vehicle and enter the correct vehicle. Similar techniques can be applied to help the driver find a rider.

In some examples, if the user devices 106 are determined to be co-present (e.g., if the likelihood is immediate), a notification can be transmitted to each user device 106 indicating the co-presence. In such cases, a duration representing how long each of the user devices 106 remain co-present can be computed. For example, the smoothed overall copresence signal can be periodically or continuously computed by the network system 102. The network system 102 can compute a difference between the start of the trip time and the end of the trip time based on the smoothed overall copresence signal to compute the duration of time that the user devices 106 were co-present.

In some examples, this computed duration is used to adjust or verify accuracy of a fare associated with a trip. In some examples, the duration is used to determine how long a courier spends at a facility. Multiple such duration determinations can be collected or aggregated across various user devices 106 that pick up goods from the same facility. These durations can be aggregated into a collection of durations that represent how long goods take to prepare for pick up at the facility. These durations are then fed as training data into an item preparation duration model (e.g., an artificial neural network or convolutional neural network) to predict how long goods take to prepare for pick up at the facility.

In examples, a first user (e.g., a requester or rider) operates the first user device 106a that executes the application 108 to communicate with the network system 102 to make a request for a transportation service such as transport or delivery service (referred to collectively as a “trip”). The application 108 determines or allows the user to specify/select a pickup location or point (e.g., of the user or an item to be delivered) and to specify a drop-off location or point for the trip. The application 108 can also present notifications indicating copresence (e.g., “You are in the wrong vehicle;” “You are in the correct vehicle and your trip has begun;” “You are moving towards your pick-up vehicle.”). In some examples, the application 108 can provide any of the disclosed notifications using haptic feedback in addition to or alternative to using displayed notifications. For example, one type of haptic feedback (e.g., a first type of vibration) can be provided to indicate different likelihoods of copresence and/or that the user is in a wrong vehicle. Another type of haptic feedback (e.g., a second type of vibration) can be provided to indicate that the user is in a correct vehicle.

In some examples, another type of haptic feedback can be provided to assist the user to reach a certain vehicle. For example, as the likelihood of copresence increases from no copresence to near copresence, the intensity of the haptic feedback can be adjusted (e.g., increased or decreased). Namely, the haptic feedback can begin with a first intensity when no copresence is detected between the first user device and the second user device. As the first user device comes closer to the second user device, such as when the likelihood of copresence becomes near, the haptic feedback can increase to a second intensity. Then, as the first user device continues coming closer to the second user device, such as when the likelihood of copresence becomes immediate from being near, the haptic feedback can increase to a third intensity.

In examples, any of the systems or devices (collectively referred to as “components”) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 5, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or devices illustrated in FIG. 1 may be combined into a single system or device, and the functions described herein for any single system or device may be subdivided among multiple systems or devices. Additionally, any number of user devices 106 may be embodied within the network environment 100, and any number, type, or combination of number and/or types of GPS signal data 110 can be embodied within the network environment 100. Furthermore, some components or functions of the network environment 100 may be combined or located elsewhere in the network environment 100. For example, some of the functions of the networked system 102 may be embodied within other systems or devices of the network environment 100. Additionally, some of the functions of the user device 106 may be embodied within the network system 102. While only a single network system 102 is shown, alternative examples may contemplate having more than one network system 102 to perform server operations discussed herein for the network system 102.

FIG. 2 is a block diagram illustrating components of the network system 102 for providing co-presence duration estimation, according to some examples. In various examples, the network system 102 accesses a plurality of GPS signals including a first set of GPS signals associated with a first device and a second set of GPS signals associated with a second device. The network system 102 aligns the first set of GPS signals with the second set of GPS signals and compute copresence probability for each pair of GPS signals in the aligned first and second sets of GPS signals. The network system 102 smooths the copresence probability for each pair of GPS signals and determine one or more copresence events based on the smoothed copresence probability for each pair of GPS signals.

To enable these operations, the network system 102 includes a device interface 202, a UI module 204, a data storage 206, a copresence engine 208, and a transport service engine 210 all configured to communicate with each other (e.g., via a bus, shared memory, or a switch). The network system 102 may also include other components (not shown) that are not pertinent to examples. Furthermore, any one or more of the components (e.g., engines, interfaces, modules, storage) described herein may be implemented using hardware (e.g., a processor of a machine) or a combination of hardware and software. Moreover, any two or more of these components may be combined into a single component, and the functions described herein for a single component may be subdivided among multiple components.

The device interface 202 is configured to exchange data with the user devices 106 and cause presentation of one or more UIs provided by the UI module 204 on the user devices 106 (e.g., via the application 108) including UIs to initiate a request for transportation service, select a pickup location and drop-off location, identify a facility from which to obtain goods for pick up, and display a route or path to navigate to the pickup location and the drop-off location.

In some examples, the UIs provide an indication of copresence (or lack of copresence) of the user devices 106 in real time. The indication can be based on real-time information representing speed between the user devices 106 and distance between the user devices 106. The indication can be generated based on GPS data obtained from the user devices 106, such as by the copresence engine 208.

The UIs can also or alternatively present the likelihoods of co-presence (e.g., immediately co-present, near, far, or none) and trigger different types of haptic feedback representing the likelihoods of co-presence using the UWB information (e.g., distance and direction between devices). The device interface 202 may also receive data including scans and trip data from the user devices 106 before, during, and after a trip. The trip data can include location information such as GPS traces (e.g., latitude and longitude with timestamp), speed, times associated with each trip, and feedback for the transportation service. The scans and trip data may be received from the user devices 106 in real-time, for example as the user is traveling (or navigation to a destination) during the trip. The scans and/or trip data are stored to the data storage 206 by the device interface 202.

The data storage 206 is configured to store information associated with each user of the network system 102 including the trip data, GPS signal data 110, and a user account/profile. The stored information includes, for example, past trips, saved or frequently selected destinations (e.g., home, work), and user preferences. In some examples, the trip data is stored in or associated with the user profile corresponding to each user and includes a history of interactions using the network system 102. While the data storage 206 is shown to be embodied within the network system 102, alternative examples can locate the data storage 206 elsewhere and be communicatively coupled to the network system 102.

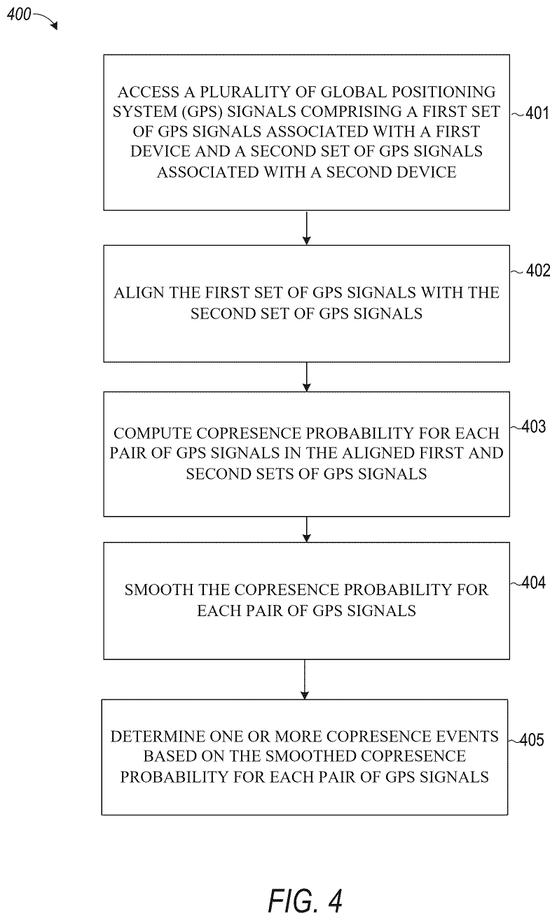

The copresence engine 208 is configured to manage copresence determination and duration computation and can be used to determining one or more copresence events based on the smoothed copresence probability (smoothed copresence signal) generated based on pairs of GPS signals. The copresence engine 208 can generated the smoothed copresence signal based on the operations and processes discussed below in connection with FIG. 4.

Specifically, the copresence engine 208 accesses a plurality of GPS signals including a first set of GPS signals associated with a first device and a second set of GPS signals associated with a second device. The copresence engine 208 aligns the first set of GPS signals with the second set of GPS signals. The copresence engine 208 computes copresence probability for each pair of GPS signals in the aligned first and second sets of GPS signals. The copresence engine 208 smooths the copresence probability for each pair of GPS signals and determines one or more copresence events based on the smoothed copresence probability for each pair of GPS signals.

In some cases, the copresence engine 208 aligns the first set of GPS signals with the second set of GPS signals by filtering the first and second sets of GPS signals to remove noise based on at least one of horizontal accuracy data or speed accuracy data. The copresence engine 208 filters the first and second sets of GPS signals by obtaining the horizontal accuracy data for each GPS signal in the first and second sets of GPS signals. The copresence engine 208 compares the horizontal accuracy data for each GPS signal in the first and second sets of GPS signals to a threshold and removes one or more GPS signals from the first and second sets of GPS signals in response to determining that the horizontal accuracy data of the one or more GPS signal transgresses the threshold. In some cases, the threshold is 50 meters.

In some examples, the copresence engine 208 filters the first and second sets of GPS signals by obtaining the speed accuracy data for each GPS signal in the first set of GPS signals. The copresence engine 208 compares the speed accuracy data for each GPS signal in the first set of GPS signals to a set of predetermined values and removes one or more GPS signals from the first set of GPS signals in response to determining that the speed accuracy data of the one or more GPS signal corresponds to the set of predetermined values. In some cases, the first set of GPS signals corresponds to the first device associated with a passenger in a ridesharing service and the set of predetermined values includes zero and negative one.

The copresence engine 208 aligns the first set of GPS signals with the second set of GPS signals by identifying a group of points within the first and second sets of GPS signals that are associated with a speed that is greater than a speed threshold and a distance that is less than a distance threshold. The group of points can correspond to a specified time interval. The copresence engine 208 cross correlates the group of points to identify a time bias representing a lag between the first and second sets of GPS signals and aligns the first and second sets of GPS signals based on the time bias.

The speed threshold can be three meters per second, the distance threshold can be three kilometers or less, and the specified time interval can be four minutes or less.

In some cases, the copresence engine 208 aligns the first set of GPS signals with the second set of GPS signals by interpolating or extrapolating the first set of GPS signals with the second set of GPS signals based on known positions of the first set of GPS signals corresponding to a rider in a ride sharing service to align the first and second sets of GPS signals based on a speed of the second set of GPS signals. The copresence engine 208 computes the copresence probability by identifying a first pair of aligned GPS signals in the aligned first and second sets of GPS signals. The copresence engine 208 computes a proximity-based copresence likelihood indicating a probability that the first and second devices are within a threshold distance of each other. The copresence engine 208 computes a speed-based copresence likelihood indicating a probability that the first and second devices are moving at respective speeds that are within a threshold speed of each other.

In some examples, the copresence engine 208 determines a maximum value of the proximity-based copresence likelihood and the speed-based copresence likelihood. The copresence engine 208 assigns, as the copresence probability for the first pair of aligned GPS signals, the maximum value of the proximity-based copresence likelihood and the speed-based copresence likelihood. In some cases, the copresence engine 208 computes the proximity-based copresence likelihood by generating a first Rician Distribution of a first horizontal accuracy associated with a first point in the first pair of aligned GPS signals and generating a second Rician Distribution of a second horizontal accuracy associated with a second point in the second pair of aligned GPS signals. The copresence engine 208 computes the proximity-based copresence likelihood based on an overlap between the first and second Rician Distributions.

The copresence engine 208 determines a range from a plurality of ranges of a speed associated with a first point in the first pair of aligned GPS signals. The copresence engine 208 sets the threshold speed to be one of a plurality of values first value based on the determined range. In some cases, the copresence engine 208 smooths the copresence probability for each pair of GPS signals by generating a smoothed overall copresence signal based on the copresence probability for each pair of GPS signals. The smoothed overall copresence signal can include individual copresence status values including at least one of true copresence, false copresence, and unknown copresence status. The copresence engine 208 selects a first group of the GPS signals in the aligned first and second sets of GPS signals and determines the copresence probability of the first group of GPS signals. The copresence engine 208 selects a first copresence status in response to determining that the copresence probabilities of the first group of the GPS signals transgresses a threshold and stores the first copresence status in the smoothed overall copresence signal.

In some examples, the copresence engine 208 transitions the first copresence status in the smoothed overall copresence signal to a second copresence status in response to determining that copresence probabilities of a second group of the GPS signals, that is subsequently adjacent in time to the first group of GPS signals, fails to transgress the threshold and vice versa. The copresence engine 208 updates weights of a model (e.g., a neural network machine learning model) to predict confidence in certain copresence events by comparing predictions made by the model with information obtained from the smoothed overall copresence signal. Specifically, the copresence engine 208 compares inferred or estimated events and features that led the copresence engine 208 to generate the events (e.g., from information obtained from the smoothed signal) to labeled ground truth data representing the events.

The transport service engine 210 obtains trip information associated with the trip taken by the first user. The transport service engine 210 can obtain this trip information based on manual user inputs received from a second user of the second user device 106b. Specifically, the second user device 106b can select an option indicating start of the trip when the first user enters the vehicle associated with the trip. Similarly, the second user device 106b can select an option indicating end of the trip when the first user leaves the vehicle associated with the trip or when the destination is reached. This information is stored in the trip information and can be used to compute a trip duration determined by the inputs from the second user.

The transport service engine 210 can compare the start time of the trip determined by the copresence engine 208 with the start time of the trip indicated by the second user of the user devices 106. If the two start times are within a threshold difference of each other, the transport service engine 210 determines that no fraud is present or detected. If the two start times are not within the threshold difference (e.g., two minutes) of each other, the transport service engine 210 determines that possible fraud is present or detected. In such cases, the transport service engine 210 can update a profile associated with the second user to determine whether a pattern of behavior indicates fraud. If multiple instances of such fraud are determined for the same second user, the transport service engine 210 can alert the second user and/or can alert a service provider about the fraud.

The transport service engine 210 can compare the end time of the trip determined by the copresence engine 208 with the end time of the trip indicated by the second user of the user devices 106. If the two end times are within a threshold difference of each other, the transport service engine 210 determines that no fraud is present or detected. If the two end times are not within the threshold difference (e.g., four minutes) of each other, the transport service engine 210 determines that possible fraud is present or detected. In such cases, the transport service engine 210 can update a profile associated with the second user to determine whether a pattern of behavior indicates fraud. If multiple instances of such fraud are determined for the same second user, the transport service engine 210 can alert the second user and/or can alert a service provider about the fraud.

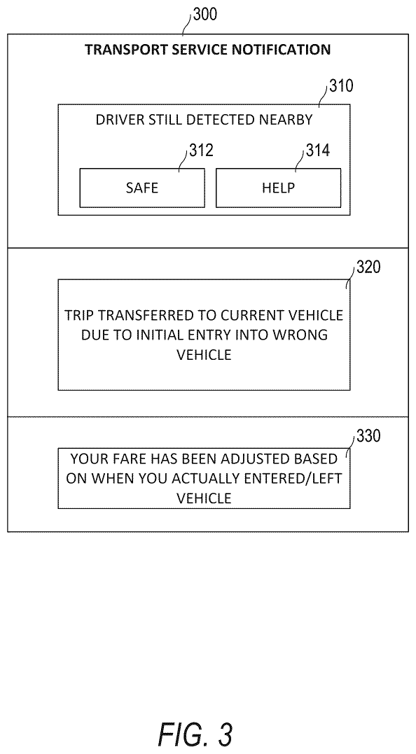

The transport service engine 210 can compare the duration of the trip determined by the copresence engine 208 with the duration of the trip computed based on inputs received from the second user of the user devices 106. If the two durations are within a threshold difference of each other, the transport service engine 210 determines that no fraud is present or detected. If the two durations are not within the threshold difference (e.g., three minutes) of each other, the transport service engine 210 determines that possible fraud is present or detected. In such cases, the transport service engine 210 can update a profile associated with the second user to determine whether a pattern of behavior indicates fraud. If multiple instances of such fraud are determined for the same second user, the transport service engine 210 can alert the second user and/or can alert a service provider about the fraud by flagging the second user device 106b for review. In response to determining that the two durations are different from each other by some threshold (e.g., five minutes), the transport service engine 210 can recompute and adjust a fare (e.g., increase or decrease the fare) initially provided to the first user when the trip began or just prior to when the trip began. The transport service engine 210 can also generate a message or prompt 330 for presentation on the first user device 106a of the first user in a UI 300, as shown in FIG. 3.

In some examples, as discussed above and below, a trip associated with the autonomous vehicle can automatically be started and ended using the likelihood of co-presence alone or together with other signals. For example, simultaneously with unlocking the door, the autonomous vehicle can start a trip (e.g., to begin charging a fare to the passenger) in response to determining that the co-presence likelihood corresponds to a near or immediate likelihood. Then, after the autonomous vehicle reaches a destination, the autonomous vehicle can automatically end the trip (e.g., to conclude charging the fare or for computing the fare total), in response to determining that the co-presence likelihood no longer corresponds to the near or immediate likelihood and corresponds to a far or none copresence likelihood.

Similarly, the transport service engine 210 can communicate with a locker that contains an item for pickup by a courier. The transport service engine 210 can compute a co-presence likelihood score between the courier and the locker based on a beacon signal strength transmitted by a user device of the locker. In response to determining that the co-presence likelihood corresponds to a near or immediate likelihood, the transport service engine 210 can instruct the locker to unlock to allow the courier to pick up the item in the locker.

In some examples, the transport service engine 210 can detect possible safety issues or concerns based on detecting co-presence between the first user of the first user device 106a and the second user device 106b after a destination is reached and/or after the second user of the second user device 106b indicates an end to the trip. Specifically, the transport service engine 210 can instruct the copresence engine 208 to collect and compute co-presence information after a destination is reached and/or after the second user of the second user device 106b indicates an end to the trip. The copresence engine 208 can instruct the second user device 106b to continue detecting RSSI for the GPS signal data 110 associated with the first user device 106a after the likelihood is determined that the first user device 106a is near the second user device 106b.

In some examples, in response to determining that the driver may be lingering around a location, the copresence engine 208 generates an alert 310 for presentation on the first user device 106a of the first user in the UI 300, as shown in FIG. 3. The alert 310 (or certain type of haptic feedback) can indicate or inform the first user that the second user (e.g., the driver) is still nearby and can provide a set of options. The alert 310 can include a first option 312 indicating that the first user is safe. Selection of the first option 312 can dismiss the monitoring and terminate monitoring of the GPS signal data 110 by the first user device 106a. The alert 310 can include a second option 314 to call for help. Selection of the second option 314 can cause the transportation manager of the transport service engine 210 to be notified about the possible safety issue, call the police, and/or call a designated friend of the first user of the first user device 106a.

FIG. 4 is a flowchart illustrating operations of a method 400 (or process) for computing copresence duration, according to some examples. Operations in the method 400 may be performed by the network system 102, using components described above with respect to FIG. 2. Accordingly, the method 400 is described by way of example with reference to the network system 102. However, it shall be appreciated that at least some of the operations of the method 400 may be deployed on various other hardware configurations or be performed by similar components residing elsewhere in the network environment 100. Therefore, the method 400 is not intended to be limited to the network system 102.

In operation 401, the network system 102 accesses a plurality of global positioning system (GPS) signals comprising a first set of GPS signals associated with a first device and a second set of GPS signals associated with a second device, as discussed above. For example, the network system 102 can access the GPS signal data 110 to obtain the first set of GPS signals that have been collected by the first user device 106a and the second set of GPS signals that have been collected by the second user device 106b. The network system 102 can access the GPS signal data 110 continuously and/or periodically.

In operation 402, the network system 102 aligns the first set of GPS signals with the second set of GPS signals, as discussed above. For example, the network system 102 can preprocess the raw GPS signals to filter and align the GPS signals. In some cases, to remove noise that may be presented in the raw GPS signals, the network system 102 removes GPS signals that are associated with horizontal accuracy that transgresses a threshold (e.g., 50 meters) of positions of the rider and driver data. This is because these points are so noisy that they will rarely have the required confidence for copresence to be met, even if the first user device 106a and the second user device 106b are actually co-present. Rather than potentially labeling a stretch of bad horizontal accuracy points as non-copresence, which can be erroneous and affect downstream algorithms, filtering upfront enables the network system 102 to simply skip these points and rely on more accurate portions of the trip.

An additional major source of error are stale or repeated positions, which can manifest in two ways. The exact location and speed of a rider/driver at a certain time is repeated more than once (duplicate points). This may not be a significant cause of error, as duplicate points are mapped to the same point during interpolation. Another way relates to a true position and speed being repeated, but the time associated with the position continuing to change. For example, the rider and driver are both moving together on a highway, when suddenly the rider position is repeated a number of times at the same position (but at new timestamps) while the driver keeps moving. This makes it seem as if a separation and potential drop-off has wrongly occurred.

The rider data is much more likely to have these stale data errors, as the source of the rider positions are raw positions. The way these errors are handled is through an observation: stale or bad rider positions are almost always accompanied by a speed or speed accuracy value of 0 or −1. In some examples, rider positions (e.g., GPS signals or coordinates obtained from the first user device 106a of a rider) are filtered to only include positions that have positive speed and speed accuracy values. Namely, the network system 102 removes any GPS signal that is associated with a speed or speed accuracy that corresponds to a certain set of values, such as 0 or −1.

In some examples, the network system 102 can align the GPS signals of the first user device 106a and the second user device 106b based on time bias. Copresence can be determined by comparing the rider and driver positions/speeds at matching times. However, the times of the rider and driver are not necessary in the same reference frame, and can differ by some offset based on the device times. These time biases can be constant and the rider and driver reference times can be aligned. The network system 102 can address these time biases by using cross correlation of the rider and driver speeds obtained from the corresponding GPS signals of the first user device 106a and the second user device 106b. Speed may be used because it is a simple and available way to detect the lag. Other simple data, like latitude or longitude, cannot always detect lag.

Because the rider and driver are not always together, the speed of the entire available data cannot be cross correlated to get accurate lag detection. Instead, it may be desirable to find a point in the trip where the rider and driver were most likely to be co-present. In such cases, the network system 102 can identify a certain time interval portion (e.g., a four minute portion) of the trip with the highest density of points in which the rider and driver were generally close to each other (within 3 km) and were both moving at a speed that indicated it would not be a human walking, defined as at least 3 m/s. The network system 102 can compute the time bias to apply to the GPS signals based on the group of points that fall within the certain time interval portion and are associated with a distance that is less than a threshold distance (e.g., less than 3 km) and move at a speed that is greater than a speed threshold (e.g., greater than 3 m/s). Only those points that met both the distance and speed thresholds can be used for the cross correlation. After finding the bias, the bias can be corrected from the rider position.

Even without a time bias, rider and driver locations are often at slightly different timestamps and need to be aligned. The network system 102 can further address or correct for misaligned timestamps using interpolation or extrapolation. Because driver positions are generally more dense than rider positions, the driver positions can be interpolated/extrapolated to the known rider times. Since the interpolation and extrapolation assume constant movement, doing so at too large a time delta can present additional uncertainty and noise. To account for this, a maximum interpolation/extrapolation time can be imposed, initially set to five seconds. Additionally, if one point is significantly closer to the desired timestamp than the next nearest, that position is relied on fully. The additional uncertainty that comes from interpolation and extrapolation can be captured in the interpolated horizontal accuracy and speed accuracy values. This would not be linear and is better modeled as combining the noise of two gaussians random variables. For interpolation, the network system 102 uses a weighted combination of the two gaussians, with a larger weight on the point it is closer to. For extrapolation, it uses the one horizontal accuracy point and relies on the known noise from speed and course accuracy to provide additional noise.

In operation 403, the network system 102 computes copresence probability for each pair of GPS signals in the aligned first and second sets of GPS signals, as discussed above. Namely, after aligning the GPS signals in the manner discussed with reference to operation 402, the network system 102 can generate instantaneous copresence probabilities for different pairs of the aligned GPS signals. The network system 102 can compute a proximity-based copresence likelihood and a speed-based copresence likelihood for each aligned pair of points. The network system 102 can then determine a maximum value between the proximity-based copresence likelihood and speed-based copresence likelihood and assign that maximum value to the respective pair of aligned GPS points.

In some cases, the network system 102 computes the proximity-based copresence likelihood using a Rician Distribution (or any other suitable distribution). The Rician Distribution is used because the algorithm is attempting to compare the distance between what is assumed to be two circularly symmetric bivariate normal random variables. The rider and driver positions are assumed to be circularly symmetric because each is defined as having a singular horizontal accuracy value. By definition, the horizontal accuracy is the radius of 68% confidence, which is analogous to one standard deviation. Since the accuracy is reported as a single number, rather than along a latitude/longitude or x/y dimension, a circular (rather than elliptical) distribution can be assumed. The positions are bivariate (latitude/longitude) and assuming the noise follows a normal distribution makes this be the exact problem a Rician Distribution solves.

The Rician distribution has a known cumulative distribution function (CDF). It is not practical to have the algorithm calculate the probability at a continuous range of distance, horizontal accuracy values, and CDF thresholds. Instead, a lookup table can be created for one very specific use case. For example, the Rician distribution can be computed given the distance between the rider and driver and their known horizontal accuracies, what is the probability that the rider and driver are within 50 m of each other. A distance threshold can be desired that gives a general sense of whether the rider and driver are very close to each other, intermediately close, or not close at all. Choosing a very small value, like 10 m, may result in a large number of potentially co-present points having very low confidence either due to distance or noise characteristics. On the other hand, choosing too large of a value may not have the accuracy required to see copresence. 50 m may represent very close points that map to high probabilities, relatively close points can still output some sort of value, and distant points can map to ˜0 probability.

In some cases, the network system 102 computes the speed-based copresence likelihood using a Rician Distribution. The speed based copresence is analogous to the proximity based score discussed above. One difference is that speed is inherently one dimensional rather than two. However, for now the network system 102 uses the same Rician distribution assumptions and setup. For speed copresence, rather than defining one specific threshold to define the CDF, the network system 102 uses three different thresholds depending on the speed of the rider and driver. This is because at very high speeds, the algorithm only wishes to ensure that the rider and driver are moving at speeds relatively close to each other. On the contrary, when the rider and driver are both moving at lower speeds, a more precise speed similarity is required to ascertain copresence via speed.

In some cases, the speed of the rider and driver are grouped into four classes each representing a different range of speeds, and speed copresence is found as follows. If the rider is moving at least 20 m/s, what is the probability that the rider and driver speeds are within 15 m/s of each other. If the rider is moving between 10 and 20 m/s, what is the probability that the speeds are within 10 m/s of each other. If the rider is moving between 5 and 10 m/s, what is the probability that the speeds are within 5 m/s of each other. If the rider is moving between 0 and 5 m/s, do not determine speed copresence and rely solely on distance based copresence. Like the distance based copresence, the CDF thresholds may seem high, but this is done to get a value that is large enough to map very close estimates to higher confidence values, intermediate differences to middling probabilities, and large differences to low confidence. On rare occasions, the speeds of the rider and driver could happen to align for several instances despite the rider and driver being nowhere near each other. This was shown to result in erroneous trip event labels. To avoid these, the speed based copresence may also specify that the rider and driver need to be somewhat close to each other. Rather than rely purely on distance, the algorithm instead relies on the proximity based copresence probability being some non-zero value, initially set to be at least 0.1.

In some examples, all sufficient speed based copresence probabilities can be mapped to one single value, initially defined as 0.8. This value can be applied as the speed based copresence probability if any of the following hold: probability of speed copresence >=0.5 if the rider speed is >=20 m/s; probability of speed copresence >=0.6 if the rider speed is between 10 and 20 m/s; probability of speed copresence >=0.7 if the rider speed is between 5 and 10 m/s.

In operation 404, the network system 102 smooths the copresence probability for each pair of GPS signals, as discussed above. Specifically, after aligning the GPS signals and computing the likelihoods of copresence for each pair of aligned GPS signals, the network system 102 can compute a smoothed copresence status signal. Despite the best attempts of the instantaneous copresence probability mapping, false positive and false negative copresence mappings may still exist due to the thresholds chosen or data issues. Combining these instantaneous probabilities into a smoothed overall status signal can help create a less noisy overall copresence status signal. In some cases, the network system 102 computes three potential states of the copresence status signal as TRUE (indicating that the first user device 106a and second user device 106b are likely to be co-present), FALSE (indicating that the first user device 106a and second user device 106b are unlikely to be co-present), and unknown. The network system 102 generates the smoothed copresence status signal by identifying a persistence of instantaneous probabilities above or below a defined threshold (initially chosen as 0.3) before an official state transition is performed. If the persistence is met, the first instance of the new state is marked as the start of the new state in the smoothed signal. Because this overall state signal can be different depending on whether the status is smoothed starting from earlier timestamps or later timestamps, it is done bidirectionally. The status from each direction must match. If the states do not match, those points in time are marked as being in the unknown state.

For example, the network system 102 can access a collection or group of a plurality of pairs of GPS signals from a first direction (e.g., from a latest timestamp to an earliest timestamp) along with the corresponding likelihoods of copresence. The network system 102 can select a group of five or more pairs of GPS signals. The network system 102 can determine the copresence probability of the first group of GPS signals and can determine whether the copresence probabilities transgress a threshold. If so, the network system 102 can update the smoothed copresence status signal for the time interval corresponding to the group of pairs of GPS signals to be a first copresence status (e.g., TRUE). If any one of the GPS signals is associated with a different copresence probability, the network system 102 maintains the corresponding point in the smoothed copresence status signal in the previously computed value for a prior time interval (e.g., TRUE or FALSE). Similarly, the network system 102 can determine the copresence probability of the first group of GPS signals and can determine whether the copresence probabilities fail to transgress the threshold. If so, the network system 102 can update the smoothed copresence status signal for the time interval corresponding to the group of pairs of GPS signals to be a second copresence status (e.g., FALSE).

For example, the network system 102 can access another collection or group of a plurality of pairs of GPS signals from a second direction (e.g., from an earliest timestamp to a latest timestamp) along with the corresponding likelihoods of copresence. The network system 102 can select a group of five or more pairs of GPS signals. The network system 102 can determine the copresence probability of the first group of GPS signals and can determine whether the copresence probabilities transgress a threshold. If so, the network system 102 can update the smoothed copresence status signal for the time interval corresponding to the group of pairs of GPS signals to be a first copresence status (e.g., TRUE). If any one of the GPS signals is associated with a different copresence probability, the network system 102 maintains the corresponding point in the smoothed copresence status signal in the previously computed value for a prior time interval (e.g., TRUE or FALSE). Similarly, the network system 102 can determine the copresence probability of the first group of GPS signals and can determine whether the copresence probabilities fail to transgress the threshold. If so, the network system 102 can update the smoothed copresence status signal for the time interval corresponding to the group of pairs of GPS signals to be a second copresence status (e.g., FALSE).

The network system 102 can compare the corresponding points for the two different smoothed copresence status signals to determine whether any of the statuses mismatch. If so, the network system 102 can update the statuses to UNKNOWN to generate the final smoothed copresence status signal. In some cases, the network system 102 can update weights of a model to predict confidence in certain copresence events by comparing predictions made by the model with information obtained from the smoothed overall copresence signal. Namely, the copresence engine 208 compares predictions from the model and the information used to generate the predictions with labeled ground truth data.

In operation 405, the network system 102 determines one or more copresence events based on the smoothed copresence probability for each pair of GPS signals, as discussed above. For example, the network system 102 can determine a first copresence event from the smoothed overall copresence signal representing the first time and rider location where the smoothed status signal indicated copresence (TRUE). The network system 102 can determine a first copresence with speed event indicating the first time and (rider) location where the smoothed status signal indicated copresence and the speed of the rider was notable (defined as >=3 m/s). The network system 102 can determine a last copresence event indicating a last time and (rider) location where the smoothed status signal indicated copresence. The network system 102 can determine a last conclusive event indicating a last time and (rider) location where the smoothed status signal indicated anything other than the unknown status, indicating a copresence status, whether true or false, is known. The network system 102 can determine a last separation event indicating a last time and (rider) location where the smoothed status signal transitioned to FALSE after previously being TRUE. The FALSE point is what is outputted. With these events, much about the trip can be determined, particularly two important parts of a trip: pickup and drop-off.

The drop-off event can be defined as the exact time and location where the rider left the vehicle of the driver. One might assume that the drop-off event is generally equal to the last separation event. While the last separation event can be a general starting point to finding the drop-off event, there are a number of reasons why this would not be an accurate drop-off event. Separation can be delayed from drop-off event due to copresence thresholding, where 50 m is currently used as the general threshold for whether or not two entities are co-present. In a normal case, it can take some measurable amount of time for 50 m of separation to be seen if two entities were co-present. In such cases, the last separation event can be be delayed from the actual drop-off event. In order to correct this, speed is again used as an indicator. Drop-off generally happens when a driver's speed is zero, so the rider can safety leave their vehicle. Therefore, backstepping from the last separation event to the time where the driver's speed first was near zero near this event provides a more exact drop-off event. In order to avoid the impact of spuriously wrong driver speeds, a median filter is applied to driver speeds when performing this backstepping step.

Separation can be delayed from dropoff event due to lost positions. A common occurrence is when there is a notable time gap between the last separation event and the last copresence event that immediately proceeds it. For example, the rider and driver could be co-present in the middle of a trip, only for locations to be lost for many minutes. When locations return, the rider and driver are no longer co-present, indicating separation. However, it is unknown where the drop-off occurred during this gap. Depending on the size of the time gap, either no drop-off event would be labeled for that trip, or a drop-off would be estimated. A guest ride is defined to be where a user calls a trip for a friend, and the friend takes the trip rather than the caller of the trip. This presents a potential problem for the copresence algorithm since the caller of the trip and the driver may get very close near pickup or drop-off (co-present), but the subsequent loss of copresence should not be seen as a drop-off since the trip is ongoing with a different person (whose location are not know). This is corrected by making use of the first copresence event with speed event. If the rider and driver never move together with a notable speed, a drop-off should not be labeled and it should be assumed that a trip never occurred between that specific rider and driver.

Depending on the use case, there may be a requirement that the dropoff event has some level of accuracy. It is therefore useful to map known features about the trip to a drop-off event confidence score. This is done by creating features from trip's copresence data that can help determine the accuracy of drop-off events. These features were generated and then mapped to confidence scores by comparing how the algorithm's outputted drop-off event compared to the actual drop-off event, as labeled by the network system 102 for over 10,000 trips. For this analysis, an inferred drop-off event was considered accurate if it was within 1 minute and 50 m of where network system 102 labeled the precise drop-off to have occurred (to account for labeling noise and provide some acceptable error). If a drop-off event is inferred without a network system 102 label, or the bounds described previously are not met, the drop-off event is considered incorrect. The features used to help get trip level confidence are as follows: Backstep Time in Seconds; Is Backstep Time Zero (Boolean); Detected Time Lag in Seconds; First Copresence with speed to drop-off time; First Copresence with speed to dropoff time less than 1 minute; First Copresence with speed to drop-off time less than 3 minutes; First Copresence with speed to drop-off distance in meters; Rider to driver distance at drop-off; Number of status state changes; Dropoff event is found using any potentially stale rider positions (Boolean). Each feature's weight can be computed via logistic regression. Logistic regression is then used to find the confidence score (as a probability) for any future trip using a trained machine learning model or other model.

FIG. 5 illustrates components of a machine 500, according to some examples, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 5 shows a diagrammatic representation of the machine 500 in the example form of a computer device (e.g., a computer) and within which instructions 524 (e.g., software, a program, an application, an applet, an app, or other executable code) for causing the machine 500 to perform any one or more of the methodologies discussed herein may be executed, in whole or in part.

For example, the instructions 524 may cause the machine 500 to execute the flow diagrams of FIG. 4. In one example, the instructions 524 can transform the general, non-programmed machine 500 into a particular machine (e.g., specially configured machine) programmed to carry out the described and illustrated functions in the manner described.

In alternative examples, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524 (sequentially or otherwise) that specify actions to be taken by that machine. Further, while only a single machine is illustrated, the term “machine” shall also be taken to include a collection of machines that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 may contain microcircuits that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein.

The machine 500 may further include a graphics display 510 (e.g., a plasma display panel (PDP), a light emitting diode (LED) display, a liquid crystal display (LCD), a projector, or a cathode ray tube (CRT), or any other display capable of displaying graphics or video). The machine 500 may also include an input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a sound card, an amplifier, a speaker, a headphone jack, or any suitable combination thereof), and a network interface device 520.

The storage unit 516 includes a machine-storage medium 522 (e.g., a tangible machine-storage medium) on which is stored the instructions 524 (e.g., software) embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered as machine-readable media (e.g., tangible and non-Attorney transitory machine-readable media). The instructions 524 may be transmitted or received over a network 526 via the network interface device 520.

In some examples, the machine 500 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (e.g., 504, 506, and/or memory of the processor(s) 502) and/or storage unit 516 may store one or more sets of instructions and data structures (e.g., software) 524 embodying or utilized by any one or more of the methodologies or functions described herein. These instructions, when executed by processor(s) 502 cause various operations to implement the disclosed examples.

As used herein, the terms “machine-storage medium,” “device-storage medium,” “computer-storage medium” (referred to collectively as “machine-storage medium 522”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 522 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 522 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium,” and “device-readable medium” mean the same thing and may be used interchangeably in this disclosure. The terms are defined to include both machine-storage media and signal media. Thus, the terms include both storage devices/media and carrier waves/modulated data signals.

The instructions 524 may further be transmitted or received over a communications network 526 using a transmission medium via the network interface device 520 and utilizing any one of a number of well-known transfer protocols (e.g., HTTP). Examples of communication networks 526 include a LAN, a WAN, the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 524 for execution by the machine 500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain examples are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various examples, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some examples, a hardware module may be implemented mechanically, electronically, or any suitable combination thereof. For example, a hardware module may include dedicated circuitry or logic that is permanently configured to perform certain operations. For example, a hardware module may be a special-purpose processor, such as a FPGA or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering examples in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In examples in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some examples, the one or more processors or processor-implemented modules may be located in a single geographic location (e.g., within a home environment, an office environment, or a server farm). In other examples, the one or more processors or processor-implemented modules may be distributed across a number of geographic locations.

### EXAMPLES

Example 1: A method comprising: accessing a plurality of global positioning system (GPS) signals comprising a first set of GPS signals associated with a first device and a second set of GPS signals associated with a second device; aligning the first set of GPS signals with the second set of GPS signals; computing copresence probability for each pair of GPS signals in the aligned first and second sets of GPS signals; smoothing the copresence probability for each pair of GPS signals; and determining one or more copresence events based on the smoothed copresence probability for each pair of GPS signals.

Example 2. The method of Example 1, wherein aligning the first set of GPS signals with the second set of GPS signals comprises: filtering the first and second sets of GPS signals to remove noise based on at least one of horizontal accuracy data or speed accuracy data.

Example 3. The method of Example 2, wherein filtering the first and second sets of GPS signals comprises: obtaining the horizontal accuracy data for each GPS signal in the first and second sets of GPS signals; comparing the horizontal accuracy data for each GPS signal in the first and second sets of GPS signals to a threshold; and removing one or more GPS signals from the first and second sets of GPS signals in response to determining that the horizontal accuracy data of the one or more GPS signal transgresses the threshold.

Example 4. The method of Example 3, wherein the threshold comprises 50 meters.

Example 5. The method of any one of Examples 2-4, wherein filtering the first and second sets of GPS signals comprises: obtaining the speed accuracy data for each GPS signal in the first set of GPS signals; comparing the speed accuracy data for each GPS signal in the first set of GPS signals to a set of predetermined values; and removing one or more GPS signals from the first set of GPS signals in response to determining that the speed accuracy data of the one or more GPS signal corresponds to the set of predetermined values.

Example 6. The method of Example 5, wherein the first set of GPS signals corresponds to the first device associated with a passenger in a ridesharing service, and wherein the set of predetermined values comprises zero and negative one.

Example 7. The method of any one of Examples 1-6, wherein aligning the first set of GPS signals with the second set of GPS signals comprises: identifying a group of points within the first and second sets of GPS signals that are associated with a speed that is greater than a speed threshold and a distance that is less than a distance threshold, the group of points corresponding to a specified time interval; cross correlating the group of points to identify a time bias representing a lag between the first and second sets of GPS signals; and aligning the first and second sets of GPS signals based on the time bias.

Example 8. The method of Example 7, wherein the speed threshold comprises three meters per second, wherein the distance threshold comprises three kilometers, and wherein the specified time interval comprises four minutes.

Example 9. The method of any one of Examples 1-8, wherein aligning the first set of GPS signals with the second set of GPS signals comprises: interpolating or extrapolating the first set of GPS signals with the second set of GPS signals based on known positions of the first set of GPS signals corresponding to a rider in a ride sharing service to align the first and second sets of GPS signals based on a speed of the second set of GPS signals.

Example 10. The method of any one of Examples 1-9, wherein computing the copresence probability comprises: identifying a first pair of aligned GPS signals in the aligned first and second sets of GPS signals; computing a proximity-based copresence likelihood indicating a probability that the first and second devices are within a threshold distance of each other; and computing a speed-based copresence likelihood indicating a probability that the first and second devices are moving at respective speeds that are within a threshold speed of each other.

Example 11. The method of Example 10, further comprising: determining a maximum value of the proximity-based copresence likelihood and the speed-based copresence likelihood; and assigning, as the copresence probability for the first pair of aligned GPS signals, the maximum value of the proximity-based copresence likelihood and the speed-based copresence likelihood.

Example 12. The method of any one of Examples 10-11, wherein computing the proximity-based copresence likelihood comprises: generating a first Rician Distribution of a first horizontal accuracy associated with a first point in the first pair of aligned GPS signals; generating a second Rician Distribution of a second horizontal accuracy associated with a second point in the second pair of aligned GPS signals; and computing the proximity-based copresence likelihood based on an overlap between the first and second Rician Distributions.

Example 13. The method of any one of Examples 10-12, further comprising: determining a range from a plurality of ranges of a speed associated with a first point in the first pair of aligned GPS signals; setting the threshold speed to be one of a plurality of values first value based on the determined range.

Example 14. The method of any one of Examples 1-13, wherein smoothing the copresence probability for each pair of GPS signals comprises: generating a smoothed overall copresence signal based on the copresence probability for each pair of GPS signals, the smoothed overall copresence signal comprising individual copresence status values comprising at least one of true copresence, false copresence, and unknown copresence status; selecting a first group of the GPS signals in the aligned first and second sets of GPS signals; determining the copresence probability of the first group of GPS signals; selecting a first copresence status in response to determining that the copresence probabilities of the first group of the GPS signals transgresses a threshold; and storing the first copresence status in the smoothed overall copresence signal.

Example 15. The method of Example 14, further comprising: transitioning the first copresence status in the smoothed overall copresence signal to a second copresence status in response to determining that copresence probabilities of a second group of the GPS signals, that is subsequently adjacent in time to the first group of GPS signals, fails to transgress the threshold.

Example 16. The method of any one of Examples 14-15, further comprising: updating weights of a model to predict confidence in certain copresence events by comparing predictions made by the model with labeled information.

Example 17. The method of any one of Examples 1-16, wherein the first device is associated with a passenger of a ridesharing service, and wherein the second device is associated with a driver of the ridesharing service.

Example 18. The method of any one of Examples 1-17, wherein the first device is associated with a courier of an item delivery service, and wherein the second device is associated with a provider of the item.

Example 19. A system comprising: one or more hardware processors; and a storage medium storing instructions that, when executed by the one or more hardware processors, cause the one or more hardware processors to perform operations comprising: accessing a plurality of global positioning system (GPS) signals comprising a first set of GPS signals associated with a first device and a second set of GPS signals associated with a second device; aligning the first set of GPS signals with the second set of GPS signals; computing copresence probability for each pair of GPS signals in the aligned first and second sets of GPS signals; smoothing the copresence probability for each pair of GPS signals; and determining one or more copresence events based on the smoothed copresence probability for each pair of GPS signals.

Example 20. A machine-storage medium storing instructions that, when executed by one or more processors of a machine, cause the machine to perform operations comprising: accessing a plurality of global positioning system (GPS) signals comprising a first set of GPS signals associated with a first device and a second set of GPS signals associated with a second device; aligning the first set of GPS signals with the second set of GPS signals; computing copresence probability for each pair of GPS signals in the aligned first and second sets of GPS signals; smoothing the copresence probability for each pair of GPS signals; and determining one or more copresence events based on the smoothed copresence probability for each pair of GPS signals.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present disclosure. For example, various examples or features thereof may be mixed and matched or made optional by a person of ordinary skill in the art.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. The specification and drawings are, accordingly, to be regarded in an illustrative rather than a restrictive sense.

What is claimed is:

1. A method comprising:
accessing a plurality of global positioning system (GPS) signals comprising a first set of GPS signals associated with a first device and a second set of GPS signals associated with a second device;
aligning the first set of GPS signals with the second set of GPS signals;
computing copresence probability for each pair of GPS signals in the aligned first and second sets of GPS signals;
smoothing the copresence probability for each pair of GPS signals; and
determining one or more copresence events based on the smoothed copresence probability for each pair of GPS signals.

2. The method of claim 1, wherein aligning the first set of GPS signals with the second set of GPS signals comprises:
filtering the first and second sets of GPS signals to remove noise based on at least one of horizontal accuracy data or speed accuracy data.

3. The method of claim 2, wherein filtering the first and second sets of GPS signals comprises:
obtaining the horizontal accuracy data for each GPS signal in the first and second sets of GPS signals;
comparing the horizontal accuracy data for each GPS signal in the first and second sets of GPS signals to a threshold; and
removing one or more GPS signals from the first and second sets of GPS signals in response to determining that the horizontal accuracy data of the one or more GPS signal transgresses the threshold.

4. The method of claim 3, wherein the threshold comprises 50 meters.

5. The method of claim 2, wherein filtering the first and second sets of GPS signals comprises:
obtaining the speed accuracy data for each GPS signal in the first set of GPS signals;
comparing the speed accuracy data for each GPS signal in the first set of GPS signals to a set of predetermined values; and
removing one or more GPS signals from the first set of GPS signals in response to determining that the speed accuracy data of the one or more GPS signal corresponds to the set of predetermined values.

6. The method of claim 5, wherein the first set of GPS signals corresponds to the first device associated with a passenger in a ridesharing service, and wherein the set of predetermined values comprises zero and negative one.

7. The method of claim 1, wherein aligning the first set of GPS signals with the second set of GPS signals comprises:
identifying a group of points within the first and second sets of GPS signals that are associated with a speed that is greater than a speed threshold and a distance that is less than a distance threshold, the group of points corresponding to a specified time interval;
cross correlating the group of points to identify a time bias representing a lag between the first and second sets of GPS signals; and
aligning the first and second sets of GPS signals based on the time bias.

8. The method of claim 7, wherein the speed threshold comprises three meters per second, wherein the distance threshold comprises three kilometers, and wherein the specified time interval comprises four minutes.

9. The method of claim 1, wherein aligning the first set of GPS signals with the second set of GPS signals comprises:
interpolating or extrapolating the first set of GPS signals with the second set of GPS signals based on known positions of the first set of GPS signals corresponding to a rider in a ride sharing service to align the first and second sets of GPS signals based on a speed of the second set of GPS signals.

10. The method of claim 1, wherein computing the copresence probability comprises:
identifying a first pair of aligned GPS signals in the aligned first and second sets of GPS signals;
computing a proximity-based copresence likelihood indicating a probability that the first and second devices are within a threshold distance of each other; and
computing a speed-based copresence likelihood indicating a probability that the first and second devices are moving at respective speeds that are within a threshold speed of each other.

11. The method of claim 10, further comprising:
determining a maximum value of the proximity-based copresence likelihood and the speed-based copresence likelihood; and
assigning, as the copresence probability for the first pair of aligned GPS signals, the maximum value of the proximity-based copresence likelihood and the speed-based copresence likelihood.

12. The method of claim 10, wherein computing the proximity-based copresence likelihood comprises:
generating a first Rician Distribution of a first horizontal accuracy associated with a first point in the first pair of aligned GPS signals;
generating a second Rician Distribution of a second horizontal accuracy associated with a second point in the second pair of aligned GPS signals; and
computing the proximity-based copresence likelihood based on an overlap between the first and second Rician Distributions.

13. The method of claim 10, further comprising:
determining a range from a plurality of ranges of a speed associated with a first point in the first pair of aligned GPS signals; and
setting the threshold speed to be one of a plurality of values first value based on the determined range.

14. The method of claim 1, wherein smoothing the copresence probability for each pair of GPS signals comprises:
generating a smoothed overall copresence signal based on the copresence probability for each pair of GPS signals, the smoothed overall copresence signal comprising individual copresence status values comprising at least one of true copresence, false copresence, and unknown copresence status;
selecting a first group of the GPS signals in the aligned first and second sets of GPS signals;
determining the copresence probability of the first group of GPS signals;
selecting a first copresence status in response to determining that the copresence probabilities of the first group of the GPS signals transgresses a threshold; and
storing the first copresence status in the smoothed overall copresence signal.

15. The method of claim 14, further comprising:
transitioning the first copresence status in the smoothed overall copresence signal to a second copresence status in response to determining that copresence probabilities of a second group of the GPS signals, that is subsequently adjacent in time to the first group of GPS signals, fails to transgress the threshold.

16. The method of claim 14, further comprising:
updating weights of a model to predict confidence in certain copresence events by comparing predictions made by the model with labeled information.

17. The method of claim 1, wherein the first device is associated with a passenger of a ridesharing service, and wherein the second device is associated with a driver of the ridesharing service.

18. The method of claim 1, wherein the first device is associated with a courier of an item delivery service, and wherein the second device is associated with a provider of the item.

19. A system comprising:
one or more hardware processors; and
a storage medium storing instructions that, when executed by the one or more hardware processors, cause the one or more hardware processors to perform operations comprising:
accessing a plurality of global positioning system (GPS) signals comprising a first set of GPS signals associated with a first device and a second set of GPS signals associated with a second device;
aligning the first set of GPS signals with the second set of GPS signals;
computing copresence probability for each pair of GPS signals in the aligned first and second sets of GPS signals;
smoothing the copresence probability for each pair of GPS signals; and
determining one or more copresence events based on the smoothed copresence probability for each pair of GPS signals.

20. A machine-storage medium storing instructions that, when executed by one or more processors of a machine, cause the machine to perform operations comprising:
accessing a plurality of global positioning system (GPS) signals comprising a first set of GPS signals associated with a first device and a second set of GPS signals associated with a second device;
aligning the first set of GPS signals with the second set of GPS signals;
computing copresence probability for each pair of GPS signals in the aligned first and second sets of GPS signals;
smoothing the copresence probability for each pair of GPS signals; and
determining one or more copresence events based on the smoothed copresence probability for each pair of GPS signals.
